(19) United States
(12) Patent Application Publication
(10) Pub. No.: US 2008/0210753 A1
(43) Pub. Date: Sep. 4, 2008

(54) LOYALTY REWARD SETTLEMENT SYSTEM AND METHOD

(75) Inventors: Molly Plozay, Omaha, NE (US); Julie Bohn, Omaha, NE (US); Chaun Heywood, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/681,689

(22) Filed: Mar. 2, 2007

(51) Int. Cl. G06K 5/00

(52) U.S. Cl. 235/380; 705/14

(57) ABSTRACT

A acquirer system used for credit card transaction processing includes a loyalty server to manage issuance of loyalty points as transactions are processed and to provide settlement features. The loyalty server uses loyalty qualifying criteria and assigned point values stored in an associated database. When points are awarded, the loyalty server records the value of the points and electronically transfers amounts from an account of a merchant to an account of the loyalty point issuer. The merchant may be multi-tiered, with the point value allotted between a central merchant organization and individual retail stores.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

In recent years, there has been a steady proliferation of loyalty programs offered to consumers. There are a variety of different models on which such loyalty programs are based, but a common feature is that they offer an incentive designed to encourage customers to conduct business with one organization rather than with competitor organizations. Such loyalty systems often take the form of point systems in which a customer is credited with a number of points for each transaction and is entitled to later exchange or redeem accumulated points for goods and/or services.

One longstanding example is the loyalty system used in the airline industry. An airline typically offers a number of points to each consumer that is correlated with the distance traveled. At certain levels, the points may be exchanged by the consumer for airline tickets.

Loyalty systems are also becoming widely used in connection with the retail sale of goods. As an example, a customer using a credit card may be awarded points by the card issuer for all transactions that are conducted using the credit card. In some instances, one point may be awarded for each dollar spent. Additional, special incentives may be awarded for credit card purchases of specific goods or at specific merchants (e.g., double points may be awarded). Such special incentives often require arrangements between the card issuer and the merchant to account for the value to the merchant of points being issued (and, ultimately, the cost to the issuer when the points are redeemed by the consumer). Generally, however, such loyalty systems are limited in flexibility and are narrow in scope.

Thus, there is a general recognition in the industry of a need for more sophisticated loyalty-based systems capable of taking into account the arrangements between the issuer of loyalty points (e.g., a credit card company, bank, airline or other entity) and the merchant that may want to also award points as an incentive to consumers. However, it is sometimes difficult for the issuer and the merchant to establish the value of the points (i.e., the value to the merchant from increased business and the ultimate cost to the issuer when points are redeemed), since such value will depend on how many consumers make purchases in order to take advantage of the program to get points and then how many of those consumers actually redeem the points. Also, such value may change over time and vary from merchant to merchant and according to the kinds of customers and products associated with the merchants. In addition, it is desired that value be realized from additional marketing that a merchant receives by being a “participating merchant” of the issuer. As a simple solution, the rewards issuer may only charge a periodic flat fee (e.g., $1000 per month) to the merchant. Thus, issuers are challenged to find pricing arrangements that cover their expense, but encourage merchant participation. Payment is often limited to participation fees, or a calculation based on sales volume, or some other complex reporting arrangement. Such arrangements are imprecise and inflexible, and may not actually reflect the value received by the merchant as points are awarded.

### BRIEF SUMMARY OF THE INVENTION

There is provided, in accordance with embodiments of the present invention, a system and method for operating a loyalty program within a financial infrastructure (such as one used by a retail coalition or retail channel) managed by a transaction processing entity that processes transactions conducted between customers and merchants, wherein loyalty points are issued by a point issuer and awarded to a customer for conducting transactions with a merchant.

In one embodiment, a method for operating a loyalty program includes establishing qualifying aspects of transactions that give rise to loyalty points, assigning a value to each loyalty point, receiving at a loyalty host a packet of transaction information defining a transaction between a merchant and a customer, identifying qualifying aspects of the transaction from the packet of transaction information, determining loyalty points to be awarded to the customer from the identified qualifying aspects of the transaction, awarding the loyalty points to the customer, and, based on the assigned point value, electronically transferring a monetary amount from an account of the merchant to an account of the point issuer to reflect the value of the awarded loyalty units. The method permits settlement or reconciliation of accounts on a daily basis (or other chosen frequency).

A more complete understanding of the present invention may be derived by referring to the detailed description of the invention and to the claims, when considered in connection with the Figures.

### BRIEF DESCRIPTION OF THE DRAWINGS

FIG. 1 is a block diagram illustrating a credit card network having a loyalty reward system, in accordance with the present invention.

FIG. 2 illustrates in greater detail the acquirer system seen in FIG. 1, including a loyalty server for managing points issued in a loyalty reward program

FIG. 3 is a flow diagram illustrating a process for issuing loyalty points and accounting for the issuance of points in the network of FIG. 1.

FIG. 4 shows the general arrangement of data in the merchant database associated with the loyalty server seen in FIG. 2, where the acquirer system manages several different loyalty programs.

FIG. 5 shows a specific arrangement of data in the merchant database seen in FIG. 4, with exemplary data illustrated for one loyalty program.

FIG. 6 illustrates a multi-tiered loyalty program administered by a card issuer, where loyalty points may be awarded both by internal businesses associated with the issuer and by external retail merchants.

### DETAILED DESCRIPTION OF THE INVENTION

There are various embodiments and configurations for implementing the present invention. Generally, embodiments provide systems and methods for issuing loyalty rewards (points) to customers in connection with retail transactions, and for settling (reconciling) the accounts of the issuer of the points (e.g., a credit card company) and the merchant where the transactions with customers are conducted. The issuer and the merchant assign value to each loyalty point in advance, so that at the time of the transaction the value of the points issued can be determined and recorded.

The issuance of loyalty points is managed by a server located at a processing system or entity that handles transactions conducted at merchant locations. In one embodiment, the processing system is an acquirer system of a credit or debit card network, which includes a loyalty host or server for determining whether points are to be issued for each credit card or debit card transaction authorized by the acquirer or processing system. If issued, the loyalty server creates a record of the points and thereafter transfers monetary amounts between accounts of the merchant and the issuer to reflect the value of the points issued.

In some embodiments, the merchant is a multi-tiered organization with a central merchant organization and a plurality of individual merchant retail locations. Since a value is assigned to each loyalty point in advance (as between the merchant and the issuer), the cost of the points (which is ultimately transferred as a monetary amount to the issuer) can be allocated between the central merchant organization (e.g., a merchant headquarters or a franchisor organization) and the individual merchant locations (e.g., individual stores or franchisees).

It should be noted that the term “point” is used herein in its broadest sense to mean any credit, item, unit or other reward issued or awarded as an incentive in a loyalty program. The reward may be designated as points to be later redeemed by the customer, as in the described embodiments. But the term is intended to broadly encompass other items that could be awarded at the time of a transaction, and may be either intangible items (e.g., a point, monetary unit, or credit) or, alternatively, tangible items (e.g. a gift, certificate, voucher or promotional product) stocked by the merchant and given to the customer upon completion of the transaction. Further, the term “merchant” is used herein in its broadest sense to encompass any entity or business that provides products and services (and that may desire to award loyalty points to any customer who may purchase those products or sources).

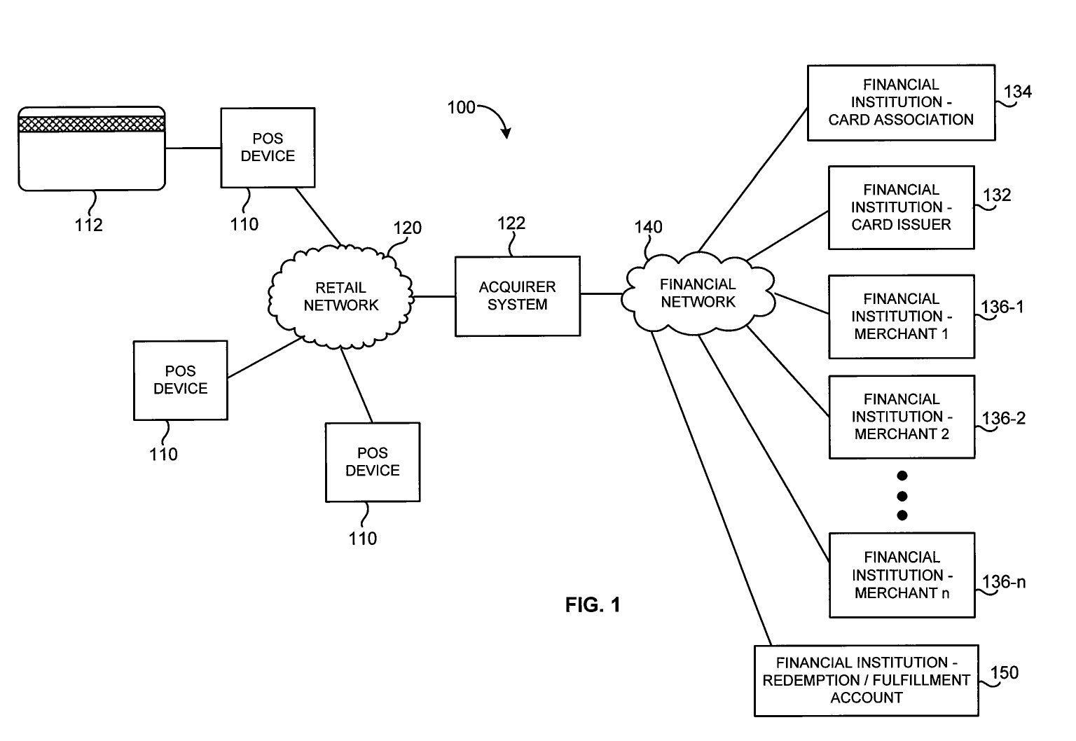

Referring now to FIG. 1, there is seen a credit card network 100 for processing payments made by a consumer or customer using a credit card 112 at one of plural POS terminals or devices 110. The credit card 112 may have a magnetic stripe with encoded credit card ID information (e.g., credit card number or account number), which may be read at a card reader located at the POS device.

The POS devices 110 are connected through a retail network 120 to an acquirer system 122. The network 120 may represent, as examples, a network maintained within a single store having a number of POS devices, a network linking a chain of stores that each have one or more POS devices 110, or a private or public network connecting POS devices at different merchant stores and different merchant chains. Such POS devices 110 collect data pertaining to transactions conducted at the terminals. Thus each devices 110 not only collects the card ID or identifier (identifying the cardholder and his/her account) read at a card reader, but also collects transaction data or information on the specific transaction (purchased product ID, store/merchant ID, transaction amount, etc.).

The acquirer system 122 receives data from the devices 110 (i.e., card identifier and transaction data), and then processes and authorizes (approves/disapproves) the credit card transaction (or a debit card or similar transaction) conducted at the POS devices 110. Acquirer systems are well known, and include those operated by credit card processing entities, such as First Data Corporation, Greenwood Village, Colo. The processing entity reconciles or settles accounts maintained for the merchants, for a card issuing entity (e.g., the bank issuing the card to the consumer), and for a card association (e.g., VISA®), MasterCard®, American Express®, etc.). Thus, as an example, when a credit card transaction is conducted at one of the POS devices 110, the acquirer system 122 may periodically debit an account at a financial institution 132 maintained for the card issuer (in order to pay the merchant), credit an association fee (e.g., a percentage of the transaction amount) to an account at a financial institution 134 maintained for the card association, and credit an account at one of the financial institutions 136-1 though 136-n that are maintained for merchants 1 through n (such merchants being those having transactions conducted at the POS devices 110). For reasons that will be described later, in some embodiments there may be separate accounts for related merchant entitles (e.g., an account for a retail chain headquarters and a separate account for each store location in the retail chain).

Payments among the various accounts are made through a financial network 140, which may represent a banking network through which ACH (Automated Clearinghouse) transfers may be made electronically to the various accounts. It should be noted that while FIG. 1 illustrates different institutions maintaining accounts for the various parties involved, some or all of the parties may use the same bank or financial institution, and in such case transfers would be made internally among the accounts at that financial institution.

As further illustrated in FIG. 1, and as will be more fully described later in connection with some embodiments, the network 100 may also include a financial institution 150 that maintains an account for a redemption/fulfillment center, into which funds may be transferred from the card issuer on account of points redeemed for merchandise or for other value at the redemption center by a customer previously awarded the points.

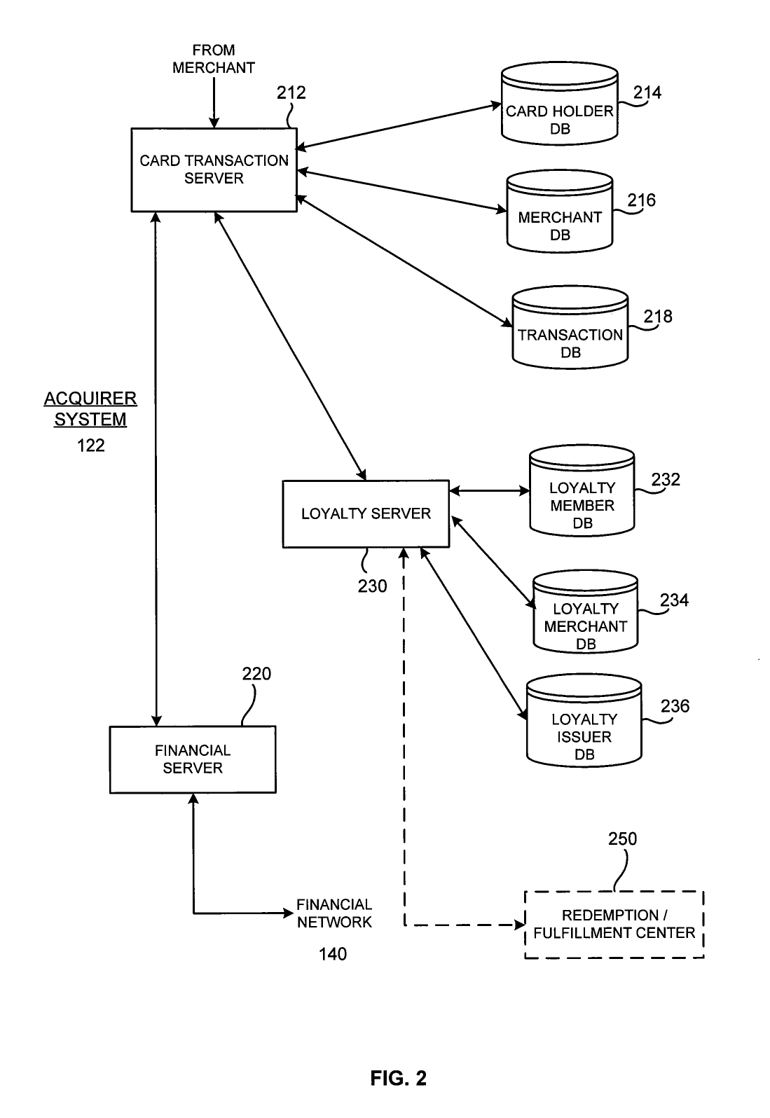

Referring now to FIG. 2, the acquirer system 122 is illustrated in greater detail. As seen, and as conventional, the acquirer system includes a card transaction server 212 which accesses several databases used in the normal handling of card transactions, including a cardholder database 214, a merchant database 216, and a transaction database 218. The cardholder database 214 stores information on each cardholder that has transactions processed by the processing entity, such as cardholder name, account number or ID, account balance, payment history and account features (interest rates, credit limits, statement start and end dates, and so forth). The merchant database 216 stores information on each merchant in the network, including merchant name and ID, merchant bank account (bank routing and account number), payment history, and so forth. The transaction database 218 stores information on individual transactions processed, including a transaction number, description of goods/services purchased, transaction amount, card account used, and so forth. When a monthly credit card statement is to be sent to a cardholder, the transaction database is used by the server 212 to prepare the statement (or used to send transaction information to the card issuer for the issuer to prepare and send a statement to the cardholder). The server 212 also communicates through a financial server 220 and the financial network 140 to various financial institutions in order to credit/debit as appropriate the accounts of merchants, card issuers and card associations, in order to post transactions and payments.

In embodiments of the invention, the financial server 220 is also used to reconcile or settle accounts in response to the issuance of loyalty points and, in some embodiments, in response to redemption of loyalty points. For such purpose, the acquirer system 122 also includes a loyalty server 230 which may manage one or more loyalty reward programs. The server 230 accesses several databases used in connection with the loyalty programs, including a loyalty member database 232, a loyalty merchant database 234, and a loyalty issuer database 236. The member database 232 stores information on each customer or loyalty program member, such as member name, loyalty account number, loyalty point balance, account history (current and previous point balances, past redemptions of points), and so forth. The merchant database 234 stores data on each merchant awarding loyalty points, including merchant name and ID, merchant address, and points that have been awarded by the merchant (i.e., to the customers identified in database 232). In some embodiments, each merchant may be part of a merchant chain or a franchising organization, and thus the merchant information may be hierarchical to match the organization, with (1) central merchant data (corresponding to the central merchant headquarters or the merchant franchisor, and reflecting cumulative data for all individual stores within the organization) and (2) individual merchant location data (the individual merchant data corresponding to each individual merchant store or franchisee). A bank or financial account identifier (bank routing and account number) for each merchant is also stored in the merchant database 234 (from which transfers may be made to the loyalty point issuer). If the merchant organization is hierarchical, an account may be identified for each central organization as well as an account for each individual merchant retail location within the central merchant organization. In some embodiments, there may be also stored in merchant database 234 a value that has been assigned to each loyalty point awarded at merchant locations so that accounts of the issuer and merchants can be reconciled, as will be described later.

The issuer database 236 stores data on each loyalty reward issuer and program, such as the name of the issuer, all transactions giving rise to loyalty rewards in that program (a transaction number, description of goods/services purchased, and points awarded for the transaction), bank or financial account identifiers, and so forth. It should be appreciated that point value data could be stored in issuer database 236 (corresponding to each merchant) in addition to or lieu of being stored in merchant database 234.

As should be apparent in the embodiment seen in FIG. 2, the transaction processing entity is both the processor of card transactions and the administrator/manager of the loyalty program (on behalf of the loyalty point issuer), and thus the transaction server 212 and loyalty server 230 (within acquirer system 122) are both operated by the same entity.

In some embodiments, the transaction processing entity operating the acquirer system 122 manages loyalty programs for a plurality of different loyalty point issuers, and thus there would not only be separate data in database 236 for each such issuer, but also separate data in member database 232 and in merchant database 234 for each such program. For example, in such instance, member database 232 would store a separate loyalty account number, loyalty point balance, and loyalty account history for each program in which a customer is enrolled. Merchant database 234 would likewise store separate merchant loyalty reward data for each loyalty program in which a merchant participates.

While not part of the acquirer system 122, FIG. 2 also illustrates a redemption/fulfillment center 250 connected to the acquirer system 122 through the loyalty server 230. In many instances, the redemption center 250 may be operated by an entity separate from the loyalty point issuer and the transaction processing entity. The redemption center 250 could be located at a retail location, and would have POS terminals and similar devices to permit a customer to redeem loyalty points. Alternatively, redemption center 250 could be a website where customers select products/services for redemption and access their loyalty accounts to use points to exchange for the selected items.

As one example, if the redemption center 250 is a physical retail location, a customer might visit the center and choose products that can be purchased using points. The redemption center accesses the loyalty server 230 in order for the customer's loyalty program membership to be confirmed and the customer's loyalty account to be accessed. Once a redemption is made, the points are deducted from the loyalty account balance (at database 232).

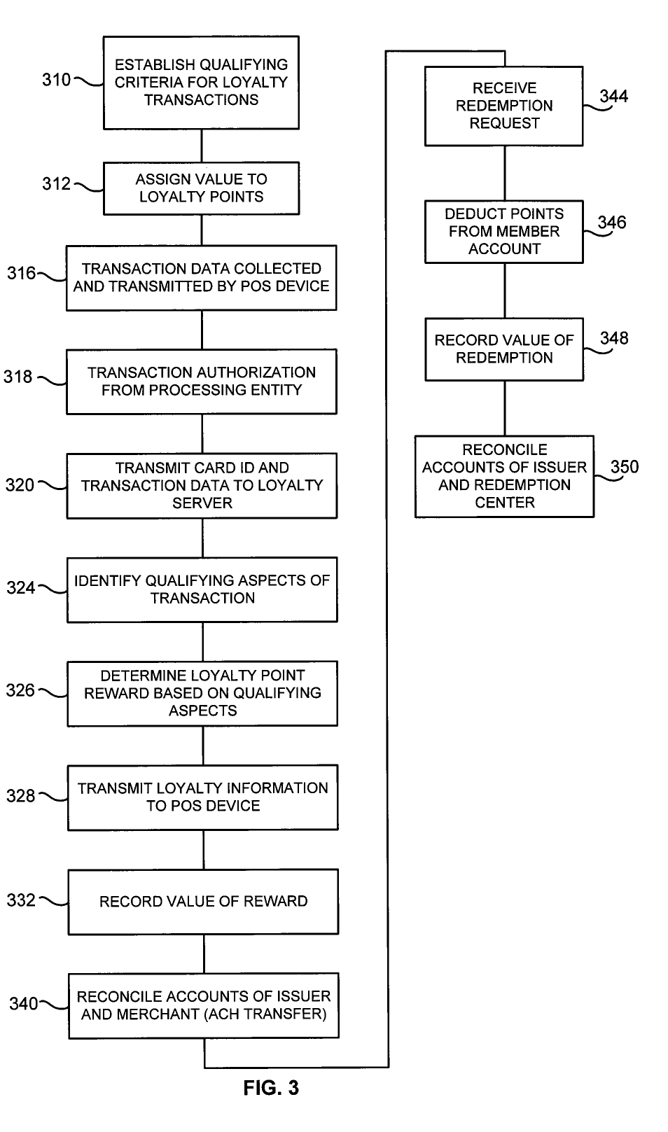

Turning now to FIG. 3, the operation of the acquirer system 122 in connection with a loyalty program is illustrated. It is assumed for purposes of explaining the process of FIG. 3 that merchants and customers have enrolled in a loyalty program managed at the loyalty server 230, and that the loyalty program has points issued by a credit card company when enrolled customers use their credit cards at participating merchants. Those same merchants have credit card (or debit card) transactions processed at the card transaction server 212. Also, identifying data and account information relating to the loyalty program for enrolled customers are stored at member database 232 and identifying data and account information for the participating merchants are stored at merchant database 234.

Initially, and in advance of transactions, qualifying criteria for loyalty transactions are established, at step 3 10. In some circumstances, the criteria may be simple, such as providing points to any purchase using the credit card (at any merchant), in which case the issuer would award points independently of the merchants and only the issuer database 236 is accessed for qualifying criteria and point award information. However, the acquirer system 122 is designed to also permit more enhanced and flexible loyalty features, such as bonus points being issued when purchases are made at specific merchants or for specific products. In such case, since the loyalty program provides an incentive to make purchases from specific merchants, those merchants and the issuer not only establish the qualifying criteria at step 310 (specific merchant or merchant location, specific product, number of bonus points awarded for the purchase, etc.), but also agree between themselves and assign a value to the points to be awarded, step 312. Examples of assigned values will be given later, but briefly the issuer and merchant could determine the value of loyalty points to the merchant (e.g., based on an anticipated increase in business) and the cost to the issuer (e.g., based on the anticipated cost of administration and cost of redemption), and arrive at a per point value that is to be paid by the merchant to the issuer. In one embodiment, such value is stored by the program administrator at merchant database 234. The assigned value can be easily adjusted or changed from time to time to reflect the experience of the merchant and issuer as points are awarded and redeemed.

When a credit card transaction is conducted at one of the POS terminals 110, transaction data (e.g., card identifier, product identifier, transaction amount) is collected at the POS terminal 110 and transmitted to the card transaction server 212 (step 3 16). The transaction server provides authorization for the card transaction (step 318) using one or more of the databases 214, 216 and 218, and either approves or disapproves the transaction based on standard qualifying credit criteria, such account existence, cardholder credit limits, merchant participation, and so forth. The transaction is then checked for eligibility under a loyalty program, such as by sending the card identifier and transaction data to the loyalty server 230 (step 320). The loyalty server then identifies and checks the qualifying aspects of the transaction, step 324. In one simple example, if the cardholder is enrolled in a loyalty program administered by the card issuer, then loyalty points could be based solely on the transaction amount (e.g., one point per dollar spent), and thus every transaction would be qualified for that award and the issuer database 236 is checked for the amount of the point awards (one point per dollar or some other predetermined point award per transaction amount). However, points could be based on more sophisticated parameters, such as the type of product purchased or the identity of the merchant where the transaction is taking place. In such circumstances, the loyalty server 230 may check the merchant database to determine the qualifying aspects of the specific transaction with the merchant (at step 324), i.e., whether the merchant or product qualifies for specific awards, and also to determine the number of additional points to be awarded (at step 326).

At step 328, the loyalty server 230 then sends the loyalty information to the POS terminal where the transaction takes place (so that the reward information can provided to the customer, e.g., printed on a receipt) and also makes a record of the reward within issuer database 236, step 332. In one embodiment, the issuer database is used to initiate the reconciliation of issuer and merchant financial accounts to reflect the awarded points, and thus all awards are stored in the issuer database 236 for that purpose. However, it should be appreciated that award data stored in the member and merchant databases 232 and 234 should be updated to reflect current awards, and for that purpose the member and merchant databases 232 and 234 could be updated at the same time.

Periodically (e.g., at the end of each day), settlement takes place. The loyalty server tabulates the value of all the points awarded to customers by each merchant and transfers the value of those points (as a monetary amount) from an account of the merchant to an account of the issuer (step 340). As illustrated in FIG. 3, the reconciliation of accounts (transfers from merchant account to issuer account) can take place through an ACH electronic transfer, initiated through financial server 220 and financial network 140 (in the same way as electronic transfers would take place when reconciling accounts to reflect the value of the underlying credit card transactions).

As also seen in FIG. 3, when the customer goes to redemption/fulfillment center 250, a redemption request is received at the loyalty server 230 (step 344), points are deducted from the loyalty account of the customer at database 232 (step 346), and loyalty server 230 then records (e.g., at issuer database 236) the value of the redeemed points, step 348. In a manner similar to the reconciliation process that takes place when points are awarded, the account of the issuer (at financial institution 132) and the account of the redemption center at financial institution 150 are periodically reconciled (e.g, via an ACH transfer from the account of the issuer to the account of the redemption center).

The progression through the flow diagram in FIG. 3 is shown for one exemplary embodiment that uses the architecture described in connection with FIG. 2. However, in other embodiments there is no requirement that the functions represented by the individual blocks be performed in the order indicated. In some alternative embodiments, the functions may be performed in a different order, some functions may be omitted, and some additional functions may be added. Further, data accessed for purposes of determining products eligible for awards, the number of points to be awarded, and the assigned value of awarded points, could be stored in databases other than merchant database 234, i.e., such data could be stored in issuer database 236 or in other databases (not illustrated) internal or external to acquirer system 122.

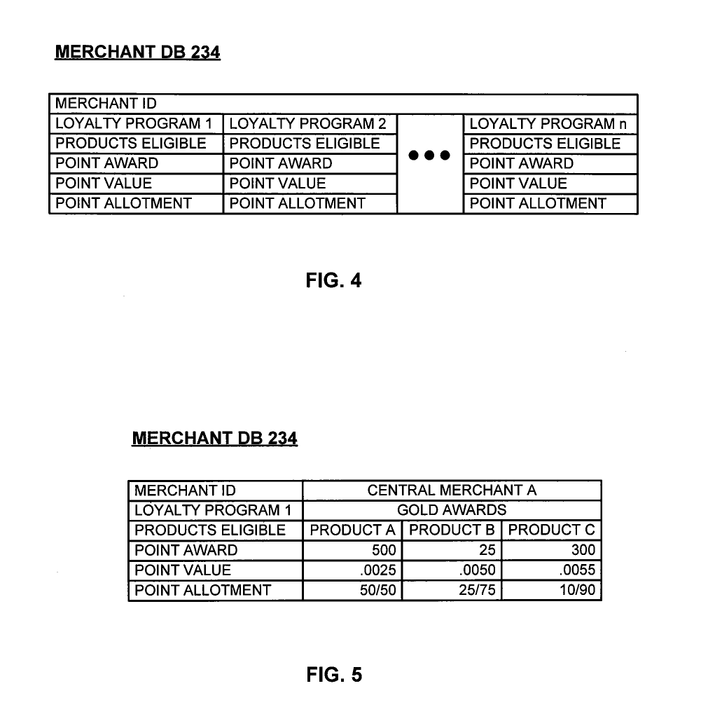

In FIG. 4, an exemplary arrangement of data in the merchant database 234 is seen. As illustrated, for each merchant (corresponding to a single merchant ID), there may be multiple loyalty programs (and corresponding loyalty program ID fields “Loyalty Program 1” through “Loyalty Program n”) in which the merchant participates. For each program there are one or more associated product IDs stored in a “Products Eligible” field, and corresponding to each product ID a “Point Award” field (storing the number of points to be awarded for that product). Also, for each loyalty program there may be a “Point Value” field (storing the value assigned at step 312, FIG. 3). While FIG. 4 anticipates that there could be plural assigned values stored under each program (one value corresponding to each product, and permitting the merchant and issuer to recognize different values for different products), in some embodiments a single point value could be assigned for all products giving rise to loyalty rewards under each loyalty program. Also seen in FIG. 4 is a “Point Allotment” field which stores a ratio or other factor that may be used if a merchant is part of a retail chain (or other large retail organization or franchise), and if the value of awarded points is to be allotted or divided between a central merchant organization and individual stores.

FIG. 5 illustrates the merchant database 234 in greater detail for one loyalty program (identified as “Gold Rewards”), and assumes that data is stored for both a central merchant organization (“Central Merchant A”) and individual merchant locations (data for the individual merchant locations are not seen in FIG. 5). In FIG. 5, there are fields for eligible products (Product A, Product B, and Product C), and the points to be awarded for each of those products. Furthermore, each product has an assigned monetary value expressed in dollars and cents (e.g., “0.0025” represents a value of 0.25¢ for each point), and for each product the allotment of the awarded points between the central merchant and individual merchant locations (e.g., “50/50” under Product A reflects that the central merchant and the individual merchant location will evenly split the cost of awarding the points for Product A). Although various fields in the database (e.g., Point Value and Point Allotment) are illustrated as having fixed data, the actual values in those fields could be variable according to programming logic associated with the database (e.g., the Point Value could be automatically varied according to an algorithm developed by the point issuer or program administrator, or as agreed to by the parties, such as being adjusted higher as points are awarded in order to reflect an increased value when heavy customer traffic results from the loyalty program).

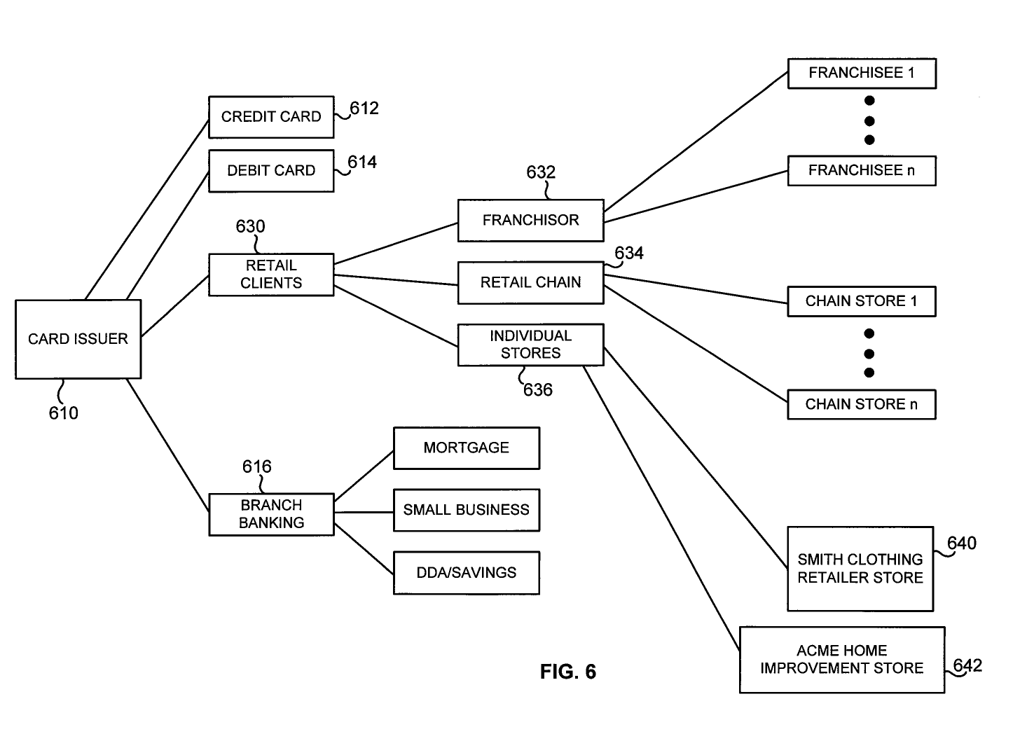

FIG. 6 illustrates a multi-tiered loyalty program established by a card issuer 610, where loyalty points may be awarded to both internal businesses associated with the issuer and to external retail merchants. In FIG. 6, it is assumed that the card issuer 610 is a financial institution or bank, which has:

(1) an internal credit card business 612;

(2) an internal debit card business 614;

(3) an internal branch banking business 616 that offer mortgages, small business services (e.g., loans, insurance, etc.), and direct deposit account/savings account services; and

(4) external retail clients 630, including a franchisor 632 having multiple franchisees (Franchisee 1-Franchisee n), an external retail store chain 634 having multiple store locations (Chain Store 1-Chain Store n), and a plurality of individual stores 636 (illustrated as including Smith Clothing Retailer Store 640 and Acme Home Improvement Store 642).

It should be appreciated the card issuer may have arrangements with any one or more of the internal and external businesses, whereby points are awarded for transactions conducted with those businesses.

### EXAMPLE

In this example, it is assumed the credit card business 612 of the card issuer “owns” the program and issues loyalty points (i.e., the acquirer system 122 is operated by a processing entity on behalf of the card issuer and the card issuer is paid by other business when awarding points). It is also assumed that the businesses participating with the card issuer are the credit card business 612, the debit card business 614, the branch banking business 616 (when offering mortgage services), Retail Chain 634, Smith Clothing Retailer Store 640 and Acme Home Improvement Store 642.

Point Rewards (Point Award Criteria for Number of Points to be Awarded)

Credit Card—1 point awarded for each $1 spent by member using credit card

Debit Card—1 point awarded for each $1 spent by member using debit card

Mortgage Business—500 points awarded for any refinance by member

Retail Chain—Bonus of 1 point for each $1 spent using credit card

Smith Clothing Retailer—Bonus of 1 point for each $1 spent using credit/debit card

Acme Home Improvement—Bonus of 1 point for each $1 spent using credit/debit card

Assigned Point Values (Agreed Value of Each Awarded Point)

Credit Card—0.001 per point

Debit Card—0.0025 per point

Mortgage Business—0.0025 per point

Retail Chain—0.005 per point

Smith Clothing Retailer—0.0055 per point

Acme Home Improvement—0.005 per point

Transactions (Transactions Giving Rise to Loyalty Points)

Member uses debit card at Acme Home Improvement and spends $100

Member uses credit card at Smith Clothing Retailer and spends $125

Member refinances a mortgage at Mortgage Business

Member uses credit card at Retail Chain Store 1 and spends $100

Point Allotment (Agreed Allotment Between Central Retail Chain and Chain Stores)

Retail Chain/Retail Chain Store—50/50

Point Awards (Points Awarded from Transaction)

Member receives 100 points for use of debit card (at Acme Home Improvement)

Member receives 100 bonus points for purchase at Acme Home Improvement

Member receives 125 points for use of credit card (at Smith Clothing Retailer)

Member receives 125 bonus points for purchase at Smith Clothing Retailer

Member receives 500 points for refinancing mortgage

Member receives 100 points for use of credit card (at Retail Chain Store 1)

Member receives 100 bonus points for purchase at Retail Chain Store 1

Account Reconciliation (Monetary Amounts Transferred to Issuer for Points Awarded)

Credit Card Business transfers 22.5¢ to card issuer (purchases at Smith Clothing and Retail chain Store 1)

Debit Card Business transfers 25¢ to card issuer (purchase at Acme Hone Improvement)

Acme Home Improvement transfers 50¢ to card issuer

Smith Clothing Retailer transfers 68.75¢ to card issuer

Mortgage Business transfers $1.25 to card issuer

Retail Chain transfers 25¢ to card issuer

Retail Chain Store 1 transfers 25¢ to card issuer

In the forgoing example, it should be understood that while the monetary amounts are illustrated as being transferred with each transaction (from the account of the business rewarding the points to the account of the card issuer), such amounts would most likely be accumulated over time, and then periodically (daily, weekly, monthly) reported and transferred. In alternative embodiments, the loyalty server 230 or financial server 220 might maintain financial accounts (apart from a financial institution or bank) for each of the parties and perform the reconciliation (resulting from points being issued) at those accounts, and then later at specified times use those accounts and their balances to initiate ACH transfers to accounts maintained for the parties at financial institutions (such as the financial institutions illustrated in FIG. 1).

While a detailed description of presently preferred embodiments of the invention has been given above, various alternatives, modifications, and equivalents will be apparent to those skilled in the art without varying from the spirit of the invention. For example, while the card transaction server 212, financial server 220, and loyalty server 230 are illustrated as separate systems, any or all of those servers could be combined into a single server/host that is programmed to carry out the functions described herein. In the same manner, while cardholder database 214, merchant database 216, transaction database 218, member database 232, merchant database 234, and issuer database 236 are illustrated as separate database systems, any or all could be combined into a single database system within acquirer system 122 or accessed as an external database. As another example, while the loyalty server 230 is illustrated as included in acquirer system 122 for use as part of credit and debit card transactions, it should be appreciated that the loyalty server 230 could be resident in other transaction processing systems (e.g., financial transaction processing systems such as check processing systems, ATM transaction processing systems, and so forth).

Therefore, the above description should not be taken as limiting the scope of the invention, which is defined by the appended claims.

What is claimed is:

1. A method for operating a loyalty program within a financial infrastructure managed by a transaction processing entity that processes transactions conducted between customers and merchants, wherein loyalty points are issued by a point issuer and awarded to a customer for conducting transactions with a merchant, the method comprising:
establishing qualifying aspects of transactions that give rise to loyalty points;
assigning a value to each loyalty point;
receiving, at a loyalty host within the financial infrastructure, a packet of transaction information defining a transaction between the merchant and the customer;
identifying qualifying aspects of the transaction from the packet of transaction information;
determining loyalty points to be awarded to the customer from the identified qualifying aspects of the transaction;
awarding the loyalty points to the customer; and
based on the awarded loyalty points and on the assigned point value, electronically transferring an amount from an account of the merchant to an account of point issuer.

2. The method of claim 1, wherein the packet of transaction information includes a customer identifier that is read from a financial card issued to the customer.

3. The method of claim 2, wherein the financial card is a credit card or debit card.

4. The method of claim 1, wherein the merchant has a hierarchical structure.

5. The method of claim 4, wherein the merchant hierarchical structure includes a central merchant organization and a plurality of merchant retail locations.

6. The method of claim 5, wherein electronically transferring an amount from an account of the merchant comprises transferring a portion of the amount from an account of the central merchant organization and a portion of the amount from an account of a merchant retail location.

7. The method of claim 6, wherein a point allotment is assigned in advance, and wherein transfers from the accounts of the central merchant organization and merchant retail location are based on the assigned point allotment.

8. The method of claim 7, wherein the point allotment is fixed.

9. The method of claim 7, wherein the point allotment may vary according to programming logic established by at least one of the merchant and the point issuer.

10. The method of claim 1, wherein the assigned point value is fixed.

11. The method of claim 1, wherein the assigned point value may vary according to programming logic established by at least one of the merchant and the point issuer.

12. The method of claim 1, wherein the transaction is conducted at a POS device by the customer, and wherein the method further comprises transmitting data representing the awarded loyalty points to the POS device.

13. The method of claim 12, wherein the method further comprises printing the awarded loyalty points on a receipt at the POS device.

14. The method of claim 1, wherein the amount is electronically transferred via an ACH transfer.

15. A system for operating a loyalty award program, comprising:
a POS device for collecting transaction data when a customer conducts a transaction with a merchant;
transaction processing server that receives the transaction data and processes the transaction;
a loyalty server for receiving the transaction data and awarding a predetermined number of loyalty points to the customer for conducting the transaction;
a database associated with the loyalty server, and storing a point value representing the value of each point awarded by the loyalty server to the customer, so that the loyalty server can calculate a monetary value of the awarded points; and
a financial server for transferring the monetary value of the awarded points from an account of the merchant to an account of a point issuer.

16. The method of claim 15, wherein the transaction data includes a customer identifier and a transaction identifier, and wherein the customer identifier is read from a financial card issued to the customer.

17. The system of claim 16, wherein the financial card is a credit card or debit card.

18. The system of claim 15, wherein the merchant has a hierarchical structure, including
a central merchant organization and a plurality of merchant retail locations, and wherein the database stores loyalty data relating to both the central merchant organization and the merchant retail locations.

19. The system of claim 18, wherein the central merchant organization is a retail chain headquarters and wherein the merchant retail locations are retail chain stores.

20. The system of claim 18, wherein the central merchant organization is a franchisor and wherein the merchant retail locations are franchisees.

21. The system of claim 18, wherein the central merchant organization is a financial institution and the merchant retail locations are internal businesses within the financial institution.

22. The system of claim 18, wherein the database stores a point allotment factor corresponding to each merchant that allocates the value of the awarded loyalty points between the central merchant organization and merchant retail location where the transaction is conducted.

23. The system of claim 22, wherein the point allotment factor is fixed.

24. The system of claim 22, wherein the point allotment may vary according to programming logic established by at least one of the merchant and the point issuer.

25. The system of claim 15, wherein the point value is fixed.

26. The system of claim 1, wherein the point value may vary according to programming logic established by at least one of the merchant and the point issuer.

27. The system of claim 1, wherein the loyalty server sends data to the POS device that represents the loyalty points awarded to the customer for conducting the transaction.

28. The system of claim 26, wherein the POS device prints the awarded loyalty points on a receipt for the customer.

29. The system of claim 1, wherein the financial server initiates an ACH transfer in order to transfer the monetary value from an account of the merchant to an account of the point issuer.

30. The system of claim 1, wherein the database maintains a loyalty account for the customer, wherein awarded loyalty points are posted to the loyalty account, wherein the system is linked to a redemption center for redeeming awarded loyalty points, and wherein the redemption center communicates with the loyalty server for accessing the loyalty account.
